(19) United States
(12) Patent Application Publication
(10) Pub. No.: US 2022/0405800 A1
(43) Pub. Date: Dec. 22, 2022

(54) Private Computation of Multi-Touch Attribution

(71) Applicant: Marin Software Incorporated, San Francisco, CA (US)

(72) Inventors: Wister Walcott, San Francisco, CA (US); Henry Corrigan-Gibbs, Somerville, MA (US)

(21) Appl. No.: 17/895,935

(22) Filed: Aug. 25, 2022

Related U.S. Application Data
(63) Continuation-in-part of application No. 17/370,256, filed on Jul. 8, 2021.
Application No. 17/370,256 is a continuation-in-part of application No. 16/158,344, filed on Oct. 12, 2018, now Pat. No. 11,087,027.

(51) Int. Cl. G06Q 30/02; H04L 9/08; G06F 21/60

(52) U.S. Cl. CPC G06Q 30/0244; H04L 9/0866; G06F 21/602; G06Q 30/0247; G06Q 2220/00

(57) ABSTRACT

A method comprises receiving an ad event data including data about a plurality of ad events, and including a user ID and an ad ID for each ad event in the ad event data set, where the ad event data set has been anonymized applying a one-way encryption key for each user ID in the ad event data set, and a two-way encryption key for the ad ID in the ad event data set. The attribution processor receives a customer data set including data about a plurality of customers, including a user ID and a customer value for each customer, where the customer data set has been anonymized using the one-way encryption key for each user ID in the data, and a private encryption key for the customer value. Without decrypting the received ad event data set and the received customer data set, the processor then matches ad events for each conversion by comparing the user IDs in the encrypted ad event data set to the user IDs in the encrypted customer data set to create a set of contributing ad events, assigns a share of the customer value to each relevant ad event, sums homomorphically the encrypted customer values for contributing events, and determines a recommendation for serving advertisements.

### CROSS REFERENCE TO RELATED APPLICATIONS

This application claims priority to, and is a continuation-in-part application of, U.S. patent application Ser. No. 17/370,256, filed on Jul. 8, 2021 and titled “Private Computation of Multi-Touch Attribution,” the contents of which are incorporated herein by reference in their entirety, and also claims priority to U.S. patent application Ser. No. 16/158,344 titled “Privacy-Safe Attribution Data Hub,” and filed on Oct. 12, 2018, the contents of which are incorporated herein by reference in their entirety.

### BACKGROUND

The disclosed embodiments relate generally to processing and organizing data. In particular, the disclosed embodiments relate to systems and methods for acquiring and processing meaningful data in an anonymized and aggregated way that satisfies the data controller's privacy requirements, while providing a metric and recommendation for the effectiveness of an advertising event. Systems and methods according to various embodiments are capable of, for example, calculating a model for how advertising investments influence business models, while improving consumer privacy.

To estimate the effectiveness of advertising, advertisers typically desire to have visibility into all the ad interactions (typically, but not exclusively, clicks or views) that may have influenced a user on the path to a purchase. For the purposes of this application, we will refer to these interactions as events. This visibility requires cooperation between advertising publishers (including advertising publishers' agents and others who work on behalf of publishers, such as advertising networks or advertising exchanges), who show the ads and receive the event information, and an advertiser (or a vendor operating on behalf of the advertiser), who collects all the events from across different publishers, attributing a contribution value to each event. A typical approach to attribution is to assign some score or credit to each event and then roll-up (or sum, or aggregate) those contribution values across all the events generated by each ad. From this information, the advertiser can then see, in total, the contributions of each ad compared to their investments in that ad and decide if they should continue investing in that ad or publisher, and to what extent. For example, an advertiser may choose to turn off an ad if it is spending money, and generating events, but if the users from those events make no purchases (in other words, if the events are not involved in, or linked to, any purchases). Each event may have several identifiers that tie back to aspects of the ad served, for example the image or text of the ad, the website where the ad appeared, the physical location of the user, keywords the user typed that triggered the ad, or other ad creative or targeting characteristics. We will refer to these identifiers as ad IDs. Each event may also receive credit in the form of several different metrics (conversions, revenue, time on site, or other metrics of interest to an advertiser). The goal is to aggregate the credits across the user events for each ad ID and return those sums to use in optimizing the advertisements.

Various models exist to attribute a value of a purchase or conversion to a given ad event. Many advertisers use or want to use an established technique called multi-touch attribution, or MTA, to adjust their advertising investments and to better understand the customer journey, with the ultimate goal of maximizing purchases or conversions from the ad investment.

Thus, multi-touch attribution can be thought of as a process that gives variable credit or “weight” to different ads and marketing channels. More specifically, it can be considered as an equation where one side of the equation uses the customer's touch points as cost per event and its unique weight; on the other side of the equation is the conversion value.

Thus, delivering a robust multi-touch attribution (“MTA”) solution requires starting with data representing a complete set of clicks, views, or other event data, along with the associated user identifiers. Of course, for any subsequent conversion, capturing event data does not imply that these views will necessarily be counted, or be given credit at all, nor does it imply what amount of credit is given, if any. But as a precursor to attributing credit, the event data must first be collected. Once a set of event data is collected, all the ad events leading to a conversion can be considered by assigning a credit (also called a conversion credit or conversion value), often a fractional credit, to each event.

The current approach to this type of cross-event, cross-ad, and/or cross-publisher attribution sends detailed event information from publishers to an attribution processor. Because of the user-level data inside this data set, the data could be used for purposes beyond attribution, such as retargeting or user profiling. The information could include the advertisement itself, other devices for a given user, search terms a user typed, on what site they saw the ad, and the target demographic for the advertisement, potentially including information about age, gender, race, marital status, and other demographic information. Publishers want to be recognized for the contribution value of the ads they show, but due to increasing government regulation, disclosure requirements, a desire to protect their audience from being further monetized by other parties, or user preference, publishers are increasingly reluctant to expose this information to others.

These privacy issues can arise in the traditional MTA process because the attribution processor system can see which individual users interacted with which ads. Data about specific users, even if masked or “pseudonymized,” may potentially expose a user to unwanted retargeting or profiling, or expose a publisher's user data for unauthorized use by third parties. In addition, several changes to the law over the last few years make collecting event data more difficult. Increasingly strict privacy, disclosure, technological, and “opt-in” regulations have made event-tracking data increasingly more difficult to assemble. Current providers, in response to simplistic early regulations, adopted a practice of “repeatable hashing” of email addresses. This hashing, also sometimes known as pseudonymization, assigns the same ID to the same user, with the ID remaining the same over time. In this arrangement, all parties use the same hash function and keys. An email hashed last year by publisher A will have the same value as an email hashed this year by publisher B. This arrangement is long-lived and repeatable, with the effect that over time, attribution providers and other vendors can build extensive dossiers on user behavior. Furthermore, any party with the original email address can simply apply the same hashing and confirm if that user is in the set, a practice sometimes known as “linking”. As a result, long-lived hashing does not address privacy requirements. Anonymization, in contrast, when applied by different parties, results in different output values for the same input values when applied repeatedly. Anonymization does not enable linking or profile-building. Anonymization is not repeatable across interactions, and is non-linkable.

To alleviate the challenges addressed with no hashing, or with long-lived hashing, the industry needs a different scheme, which provides full anonymization.

Thus, a need exists to share event data for cross-publisher, aggregated, anonymous, privacy-safe attribution, while preventing (rather than enabling) retargeting, audience building, data leakage, audience re-use, and profile building.

### SUMMARY

In an embodiment, a plurality of user identifiers in an ad views data set from a publisher (also called a “publisher user data set”) is anonymized and forwarded to an attribution processor, and a plurality of user identifiers in a customer data set from an advertiser is anonymized and forwarded to the same processor. Without de-anonymizing any user identifiers in either of the received data sets, the processor obliviously computes an intersection among the received data sets to create an intersection set containing a plurality of user identifiers that were present in both the ad views data set and the customer data set.

For each intersection in the computed intersection set, the processor computes a conversion value obliviously based on a conversion model, creating a conversion data set. The processor then sums the conversion values across each distinct ad attribute in the ad views data set, creating a converting ads data set. The advertiser then calculates an advertising recommendation for each ad based on the summed conversions and other metrics for that ad such as how much money was spent on the ad or how many users the ad was shown to. The advertiser then sends the calculated advertising recommendation to the publisher.

In an embodiment, a processor receives a plurality of anonymized publisher-user identifiers, and also receives a plurality of anonymized advertiser-user identifiers. Without de-anonymizing any publisher-user identifiers in the received plurality of publisher-user identifiers, and any advertiser-user identifiers in the received plurality of advertiser-user identifiers, the processor obliviously computes an intersection among the received publisher-user identifiers and the received ad-user identifiers to create an intersection set containing the computed intersections (if any) among the plurality of advertiser-user identifiers and the publisher-user identifiers. A plurality of data in the conversion data set is then aggregated, and an advertising recommendation is calculated based on the aggregated data set.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a system for processing, analyzing, and organizing data in a fully anonymous and aggregated way.

FIG. 2 is a flow chart of a method for the private and secure calculation and delivery of an advertising recommendation to a publisher, according to an embodiment of the invention.

FIG. 3 is a flow chart of a method for the private and secure calculation and delivery of an advertising recommendation between a plurality of publishers and an advertiser, according to an embodiment of the invention.

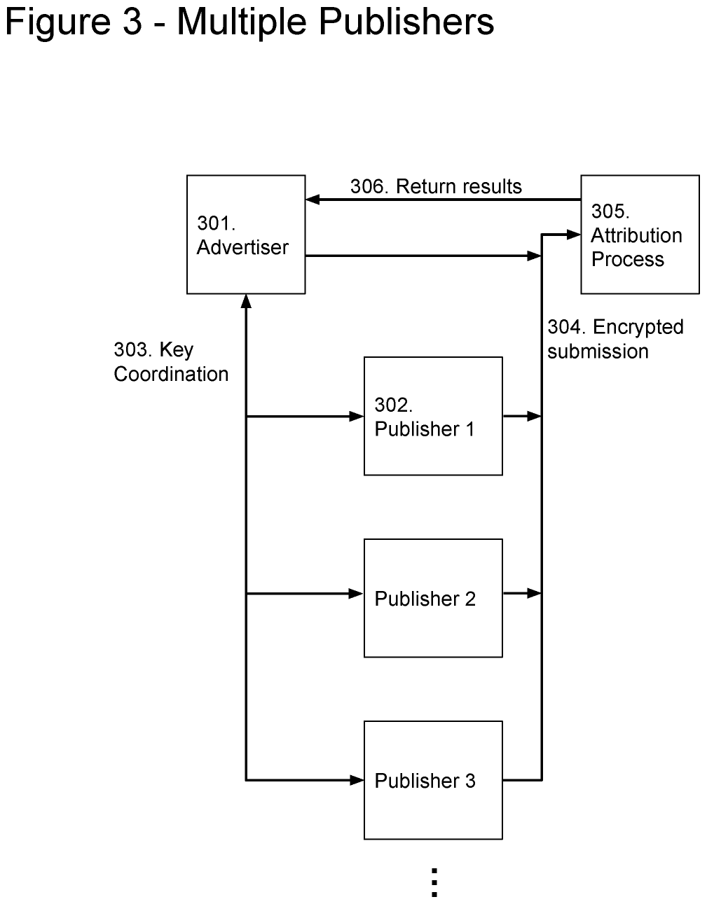

FIG. 4 is a table displaying an example of an ad views data set from a publisher, according to an embodiment.

FIG. 5 is a table displaying an example of a customer data set from an advertiser, according to an embodiment.

FIG. 6 is a table displaying an output file representing a converting ads data set, according to an embodiment.

FIG. 7 is a flow chart of a method for the private and secure calculation and delivery of an advertising recommendation to a publisher using a double-encryption method, according to an embodiment of the invention.

### DETAILED DESCRIPTION

One or more of the systems and methods described herein describe a way of processing advertising data in an anonymized and aggregated way that satisfies the privacy and information requirements of the data controllers (later referred to as one or more advertising publishers and an advertiser). As used in this specification, the singular forms “a,” “an,” and “the” include plural referents unless the context clearly dictates otherwise. Thus, for example, the term “a computer server” or “server” is intended to mean a single computer server or a combination of computer servers. Likewise, “a processor,” or any other computer-related component recited, is intended to mean one or more of that component, or a combination thereof. One skilled in the art will understand that a web page is a document on the Internet, and that a website comprises one or more web pages that are linked together. For the purposes of the present invention, the terms “ad” and “advertisement” are used interchangeably.

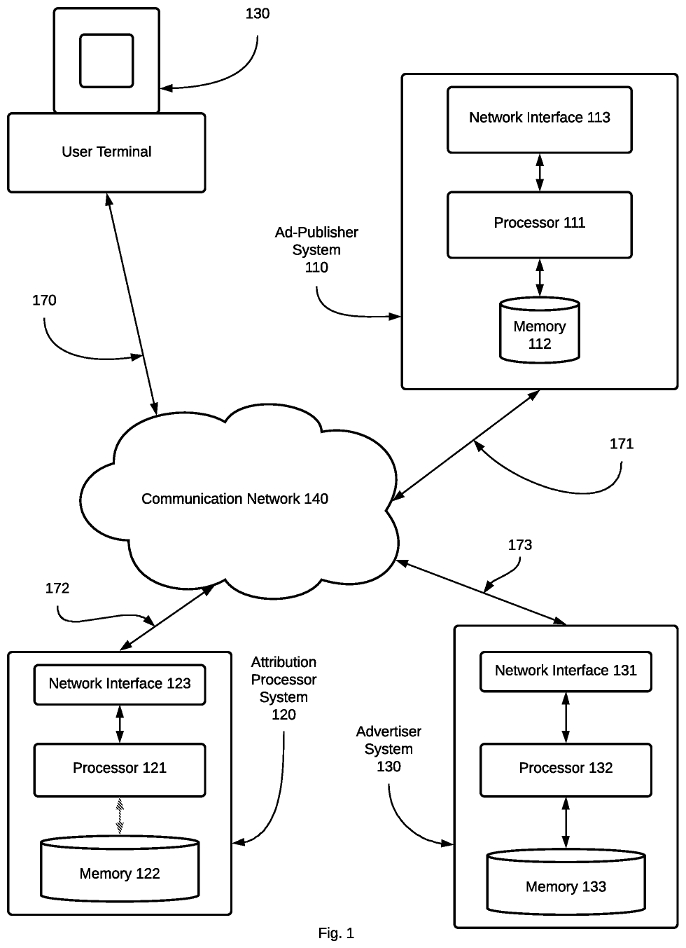

FIG. 1 is a block diagram illustrating a system for processing, analyzing, and organizing advertising data in an anonymized and aggregated way, according to an embodiment of the invention. The system comprises user terminal 100, ad publisher system 110, and attribution processor system (also called ad attribution vendor or attribution vendor) 120, and advertiser system 130. In an embodiment, attribution processor system 120, user terminal 100, ad publisher system 110, and advertiser system 130 are operatively coupled to one another through communication network 140 via network connection 170, which connects user terminal 100 to communication network 140, network connection 171, which connects ad publisher system 110 with communication network 140, and network connection 172, which connects attribution processor system 120 with communication network 140, and network connection 173, which connects advertiser system 130 with communication network 140.

Network connections 170, 171, 172, and 173 can be any appropriate network connection, physical, wireless, or otherwise, for operatively coupling user terminal 100, attribution processor system 110, ad publisher system 120, and advertiser system 130 to communication network 140.

Communication network 140 can be any communications network configurable to allow attribution processor system 120 to communicate with or to other network elements through communication network 140. Communication network 140 can be any network or combination of networks capable of transmitting information (e.g., data and/or signals) and can include, for example, a telephone network, an Ethernet network, a fiber-optic network, a wireless network, and/or a cellular network. In some embodiments, communication network 140 can include multiple networks operatively coupled to one to another by, for example, network bridges, routers, switches and/or gateways. For example, user terminal 100 can be operatively coupled to a cellular network, attribution processor system 120 can be operatively coupled to an Ethernet network, and ad publisher system 110 can be operatively coupled to a fiber-optic network. The cellular network, Ethernet network and fiber optic network can each be operatively coupled one to another via one or more network bridges, routers, switches and/or gateways such that the cellular network, the Ethernet network and the fiber-optic network are operatively coupled to form a communication network. Alternatively, for example, the cellular network, the Ethernet network, and the fiber-optic network can each be operatively coupled to the Internet such that the cellular network, the Ethernet network, the fiber-optic network and the Internet are operatively coupled to form a communication network.

In some embodiments, a network connection can be a wireless network connection such as, for example, a wireless fidelity (“Wi-Fi”) or wireless local area network (“WLAN”) connection, a wireless wide area network (“WWAN”) connection, and/or a cellular connection. In some embodiments, a network connection can be a cable connection such as, for example, an Ethernet connection, a digital subscription line (“DSL”) connection, a broadband coaxial connection, and/or a fiber-optic connection. In some embodiments, a user terminal, partner application and/or ad publisher system can be operatively coupled to a communication network by heterogeneous network connections. For example, a user terminal can be operatively coupled to the communication network by a WWAN network connection, a partner application can be operatively coupled to the communication network by a DSL network connection, and an ad publisher system can be operatively coupled to the communication network by a fiber optic network connection. In some embodiments, the data flowing across the network connections and communications network flow through a physical connection from one element to another.

In an embodiment, attribution processor system 120 comprises a network interface 123, a processor 121, and a memory 122. Attribution processor system 120 is operatively coupled to user terminal 100 and ad publisher system 110 through communication network 140 via network connection 172. User terminal 100 is connected to attribution processor system 120 through communication network 140 via network connection 170, and ad publisher system 110 is operatively coupled to user terminal 100.

In an embodiment, network interface 123 can be any network interface configurable to be operatively coupled to communication network 140 via network connection 172. For example, a network interface can be a wireless interface such as, for example, a worldwide interoperability for microwave access (“WiMAX) interface, a high-speed packet access (“HSPA”) interface, and/or a WLAN interface. A network interface can also be, for example, an Ethernet interface, a broadband interface, a fiber-optic interface, and/or a telephony interface.

In an embodiment, both the ad publisher system 110 and attribution processor system 120 can be based on any combination of hardware and software. In an embodiment, ad publisher system 110 includes network interface 113, processor 111, and memory 112. Ad publisher system 110 is operatively coupled to communication network 140 via network interface 113 and network connection 171. Network interface 113 can be any network interface configurable to be operatively coupled to communication network 140 via network connection 171. For example, a network interface can be a wireless interface such as, for example, a worldwide interoperability for microwave access (“WiMAX) interface, a high-speed packet access (“HSPA”) interface, and/or a WLAN interface. A network interface can also be, for example, an Ethernet interface, a broadband interface, a fiber-optic interface, and/or a telephony interface.

Processor 111 is operatively coupled to network interface 113 such that processor 111 can be configured to be in communication with communication network 140 via network interface 113. In an embodiment, processor 111 (and processor 121) can be any of a variety and combination of processors, and can be distributed among various types and pieces of hardware, or even across a network. For example, a processor can be any combination of aggregation processor, attribution processor, and optimization processor, including some or all of each component. Such processors can be implemented, for example, as hardware modules such as embedded microprocessors, microprocessors as part of a computer system, Application Specific Integrated Circuits (“ASICs”), and Programmable Logic Devices (“PLDs). Some such processors can have multiple instruction executing units or cores. Such processors can also be implemented as one or more software modules in programming languages as Java, C++, C, assembly, a hardware description language, or any other suitable programming language. A processor according to some embodiments includes media and program code (which also can be referred to as code) specially designed and constructed for the specific purpose or purposes. A processor according to some embodiments includes a trusted execution environment, also known as a TEE or enclave. A TEE protects data inside the TEE from being viewed by any code, or system, or person, outside the TEE. A TEE also measures what code has run on the data inside the TEE and attests to that measurement. This measurement and attestation serves to verify that the only code to run on the data is the code that the parties expect. Examples of current TEEs may include, but may not be limited to, Intel Software Guard Extensions (Intel SGX), AMD PSP, AMD SEE, ARM TrustZone, RISC MultiZone STEE, and Google Asylo.

Processor 111 is also operatively coupled to memory 112 which, in an embodiment, can be used to store advertisements, advertisement-related data, web pages, searches, search results, and any other data necessary for attribution processor system 120 to perform at least a part of the invention. In an embodiment, memory 112 (and memory 122) can be a read-only memory (“ROM”); a random-access memory (RAM) such as, for example, a magnetic disk drive, and/or solid-state RAM such as static RAM (“SRAM) or dynamic RAM (“DRAM), and/or FLASH memory or a solid-data disk (“SSD), or a magnetic, or any known type of memory. In some embodiments, a memory can be a combination of memories. For example, a memory can include a DRAM cache coupled to a magnetic disk drive and an SSD.

In addition to memories 112 and 122, some embodiments include another processor-readable medium (not shown in FIG. 1) having instructions or program code thereon for performing various processor-implemented operations. Examples of processor-readable media include, but are not limited to: magnetic storage media Such as hard disks, floppy disks, and magnetic tape; optical storage media Such as Compact Disc/Digital Video Discs (“CD/DVDs), Compact Disc-Read Only Memories (“CD-ROMs), and holographic devices: magneto-optical storage media such as floptical disks; Solid state memory such as SSDs and FLASH memory; and ROM and RAM devices. Examples of program code include, but are not limited to, micro-code or micro-instructions, machine instructions (such as produced by a compiler), and files containing higher-level instructions that are executed by a computer using an interpreter. For example, an embodiment (or parts thereof) may be implemented using HTML, Java, C++, or other object-oriented programming language and development tools. Additional examples of program code include, but are not limited to, control signals, encrypted code, and compressed code.

In some embodiments, ad publisher system 110 can be virtual devices implemented in Software such as, for example, a virtual machine executing on or in a processor. For example, an ad publisher system or an attribution processor system can be implemented, at least in part, as a software module executing in a virtual machine environment such as, for example, a Java module executing in a Java Virtual Machine (“JVM), or an operating system executing in a VMware virtual machine. In some embodiments, a network interface, a processor, and a memory are virtualized and implemented in software executing in, or as part of, a virtual machine.

Likewise, Processor 121 is operatively coupled to network interface 123 such that processor 121 can be configured to be in communication with communication network 140 via network interface 123. Processor 121 is also operatively coupled to memory 122 which, in an embodiment, can be used to store an attribution model, attribution-model data, advertisement-related data, program code, analytics, web pages, and any other data necessary for attribution processor system 120 to perform at least a part of the invention.

In some embodiments, an attribution processor system can be a virtual device implemented in software such as, for example, a virtual machine executing on or in a processor. For example, an attribution processor system can be a software module executing in a virtual machine environment such as, for example, a Java module executing in a Java Virtual Machine (“JVM), or an operating system executing in a VMware virtual machine. In some embodiments, a network interface, a processor, and a memory are virtualized and implemented in software executing in, or as part of, a virtual machine.

User terminal 100 can be any kind of user platform, such as a desktop computer, a laptop computer, a mobile telephone, a mobile tablet, or any device that allows a user to view an advertisement.

In an embodiment, a user can use user terminal 100 to log into their user account on, for example, a social-media website. When the user logs into their account, they are served an advertisement by ad publisher system 110 via communication network 140 where it can be viewed or clicked on by the user. For the purposes of the present invention, such an event is called an advertising event, and some set or subset of the ad event details (that is, the data about the ad-viewing event) are received, via communication network 140, by ad publisher system 110, which can store the ad-event details in memory 112. Ad-event details can include, for example, the account information of the user, their name, age, gender, and other demographic information. The user may identify themselves to the ad publisher by including other identifying information such as an email address, phone number, mailing address, and/or network address. These elements can be referred to as “user identifiers.” The ad-event details can also include the advertisement itself, an ad identifier that refers to the advertisement, what type of advertisement is served, the platform it is served on, the date it is served, the time it is served, the type of ad campaign, the product or other subject matter contained in the ad, whether the campaign is branded or non-branded, and any other advertising information relevant to an ad publisher or an advertiser. For the purposes of the present invention, the term “identifier” can also be referred to as an “ID.”

In an embodiment, for a given set of advertisements, ad publisher system 110 receives ad-event details that pertain to a single user. In an embodiment, for a given set of advertisements, ad publisher system 110 receives event details that pertain to a plurality of users. In an embodiment, advertiser 130 receives a purchase from one or more users.

In an embodiment, publisher 110 and advertiser 130 communicate through network interface 113 to generate one or more values known only to the publisher and advertiser, and not to the attribution processor 121 or anybody else. We will call this value a “private key.”

In an embodiment, processor 111 accesses the ad views data set in memory 112, encrypts the user identifiers using the private key, and sends them, through network interface 113, and via communication network 140, to attribution processor system 120. It will be understood that encrypt as used here is a term of art that could mean any of several methods for obfuscating information, including one-way hashing or symmetric encryption.

In an embodiment, processor 132 accesses the customer data set in memory 133, encrypts the user identifiers using the private key, and sends them, through network interface 131, and via communications network 140, to attribution processor system 120.

Once received, processor 121 can compare the encrypted and received data sets, looking for common encrypted identifiers, to generate an intersection set.

Processor 121 then looks across the intersection set for all the ad events for a specific purchase and calculates an attribution credit for each ad event found in the converting events data, creating an attribution data set.

Once the credit for each conversion event is applied, in an embodiment, the attribution data set can be aggregated (summed) directly across a plurality of users.

In an embodiment, once the attribution credit for each purchase is applied by processor 121, it is aggregated by processor 121 which sums the attributed amount for each ad identifier to provide an aggregated attribution credit for that ad ID. Processor 121, in an embodiment, then further processes the data to create an advertising recommendation that is then sent to an ad publisher directly or through an advertiser.

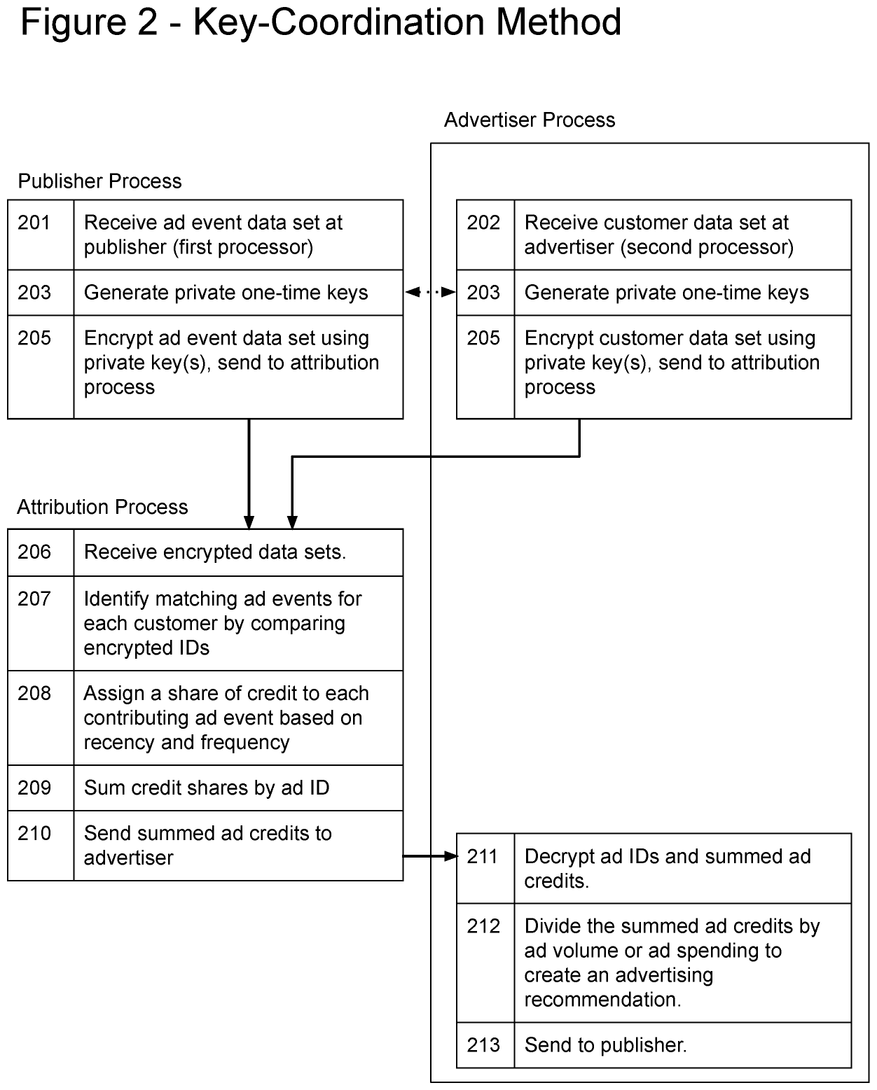

FIG. 2 is a flow chart of a method for calculating and sending an advertising recommendation to a publisher, according to an embodiment of the invention. In an embodiment, the process in FIG. 2 is implemented by at least a subset of components in FIG. 1. Under the method, a publisher processor and advertiser processor communicate confidentially to generate and agree on a set of encryption keys that each processor will apply equally. This method ensures that the original values can be correctly compared, but protects those values from being seen or used by any other processor beyond the first two. We shall call this method the “key-coordination” method.

At 201, a first processor (also called an attribution processor) receives an ad data set that includes information about advertising events. In an embodiment, the information is about advertising events that have been viewed by at least one user who has been served an ad or a plurality of ads. In an embodiment, the information is about advertising events at an advertising publisher that pertain to a product of interest to an advertiser. In an embodiment, the advertising events can include different advertisements that have been served on one or more platforms. In an embodiment, the advertising events can include views of the same advertisements, but at different times, across one or more platforms. In yet another embodiment, the advertising events can include a view of or a click on any combination of advertisements served at any combination of times, on any combination of platforms.

For the purposes of the present invention, the term platform means a type of device capable of receiving a broadcast or connecting to a network, and then displaying a served advertisement. Examples of different platforms include, but are not limited to, personal computers, laptops, mobile or cellular telephones, electronic tablets, electronic books, tablets, and any other appropriate device.

In an embodiment, the event data set includes attributes about the ad that identify the particular ad that was served or published. For example, the ad may be text, still image, or video, or a combination of those elements. In an embodiment, the ad attributes may also include an identifier or ad ID, targeting criteria that trigger the ad, such as a keyword, or the user criteria to be targeted, also known as an audience, or where the ad should be shown, known as a placement.

At 202, in an embodiment, a second processor receives information about purchases or other actions taken by a user at an advertiser. In an embodiment, the information may contain details about the purchase, such as the size of the purchase, or the products involved. In an embodiment, the information may contain identifying information about the user such as their name or email address or IP address or physical street address.

At 203, in an embodiment, the first processor (Publisher) and the second processor (Advertiser) connect with each other to decide on a set of narrowly-shared private keys which will be used to protect the data sets from eavesdropping by outsiders and from the attribution processor as well. In an embodiment, a one-way key is generated for use with user identifiers (also called “user IDs”), and a two-way key is generated for use with ad identifiers (also called “ad IDs”). In an embodiment, the Publisher and the Advertiser first authenticate each other based on an existing trusted relationship or system such as a website or personal communication, and establish a private communication channel. In an embodiment, the processors may use a known key exchange protocol such as Diffie-Hellman Key Exchange to set up the private channel. The key exchange allows the Advertiser and Publisher to jointly generate a one-way hash key at random, sometimes called a nonce, to be used for obscuring user IDs. In an embodiment, the Advertiser or Publisher also decide on a random timestamp offset function. In an embodiment, the Publisher or Advertiser also decide on a symmetric encryption protocol and key to obscure ad attributes from the attribution process. In an embodiment, the Publisher and Advertiser also decide on an homomorphic encryption protocol and necessary parameters to obscure conversion and revenue data sent by the advertiser. The Advertiser and Publisher share such generated keys between the two of them while protecting the keys from being seen or discovered by any outside parties. This information together comprises the private keys.

For the purposes of the present invention, “narrowly-shared” means that the keys are only known to the specific processors doing the encryption and are not known to any other parties.

In an embodiment, there may be a plurality of publishers. In this embodiment, the advertiser picks a private or narrowly-shared key to use with the plurality of publishers. Each publisher in the plurality of publishers will use that narrowly-shared key.

At 205, in an embodiment, the first processor encrypts the ad event data set using the private keys. In an embodiment, if there are multiple user identifiers for a given user, the processor will encrypt or hash each of the available user identifiers and link them together. In an embodiment, the first processor also encrypts the ad identifiers using the appropriate private key and a symmetric encryption approach such as AES. In an embodiment, the first processor also encrypts the timestamp of the ad event by adding a large random offset calculated from the user identifier. In an embodiment, the ad event data set is further obscured by scrambling the order of the rows before or after encryption. In an embodiment, the hashing approach used would use a secure, one-way hash function such as SHA-256. In an embodiment, the first processor will then send the encrypted ad events data set to the attribution processor.

At 205, in an embodiment, the second processor encrypts the customer data set using the private keys. In an embodiment, if there are multiple user identifiers for a given user, encrypt each of the identifiers separately and link them together. In an embodiment, the ad event data set is further obscured by scrambling the order of the rows before or after encryption. In an embodiment, the second processor also encrypts the timestamp of the ad event by adding a large random offset calculated from the user identifier. In an embodiment, the second processor also encrypts the revenue value of the conversion event using an homomorphic encryption scheme such as Paillier or El Gamal. In an embodiment, the original revenue value may be further limited to a limited list of distinct values (for example, 256 distinct values) to prevent identification of individuals from the totals. In an embodiment, the second processor will then send the encrypted customer data set to the attribution processor.

At 206, the attribution processor receives the encrypted data sets. At 207, in an embodiment, the attribution processor compares the user identifiers in the two data sets to each other to identify overlap. In an embodiment, the processor will use the linkage information in the data sets to count a single intersection even if there were multiple matching user identifiers (such as phone number and full name). In an embodiment, the processor will compare the encrypted timestamps to determine the relative sequence between the ad event and the purchase, and how much time elapsed from the first event to the second.

In an embodiment, if there are multiple publishers, the attribution processor will compare the encrypted advertiser data set with each received encrypted publisher data set to create a single intersection set consisting of the encrypted advertiser data set and any matching set members from across all the encrypted publisher data sets.

At 208, in an embodiment, the processor assigns a share of credit to each of the ad events that preceded a conversion event for a given user identifier, whereby each contributing ad event receives a fraction of credit but the total credits allocated across all the ad events for each conversion sum to 1.

In an embodiment, in the case of multiple ad events that all match to a single customer conversion event, the processor will divide the credit across the contributing ad events based on the relative frequency of that ad event and its recency to the conversion event. In an embodiment, weightings are applied according to a series of rules set by the advertiser and communicated to the data processing party ahead of time. Rules can include how much weight to give to various events, including (but not limited to) any or all of the following: last click (publisher with the earliest time stamp); first click (publisher with earliest time stamp); even weighting (all matching publisher events get the same weighting); “U shaped” (first and last get outsized credit and ones in the middle get less); and/or recency weighted (ascending or descending weighting over time). In an embodiment, conversion events can be weighted giving greater weight to certain types of events over other types of events. One skilled in the art will understand that the aggregate sum of the credit allocated should total the conversion event value. In an embodiment, the credit is multiplied with the revenue amount to apply a revenue weighting. In an embodiment, this multiplication shall be done according to the rules of the homomorphic encryption scheme mentioned earlier.

At 209, in an embodiment, the processor sums the conversion credits across all the converting ad events for each distinct ad ID or other attribute, resulting in a converting ads data set that is more accurate because it considers the impact of multiple publishers simultaneously, whereas with publisher tracking, users that visit multiple publishers and then convert cause each publisher to take full credit for that conversion. Provided a sufficient quantity of users exists, the act of aggregation further anonymizes the data. In an embodiment, if an insufficient quantity of users exists for a particular ad ID, the credits for that ad ID will be summed further into a “catch-all” category to ensure that no user can be identified based on their ad ID viewed. At 210, this data set is then returned to the advertiser and/or publisher.

At 211, in an embodiment, if the calculations are performed using encrypted revenue values, the converting ads data set is returned to the advertiser processor, which then decrypts the ad IDs and the summed revenue values. In an embodiment, the ad identifiers are also decrypted using an appropriate two-way private key. In an embodiment, at 212, the advertiser or publisher divides the conversion values for each ad ID or other attribute by the total amount spent on that ad, or the number of ad views the ad received, to calculate an advertising recommendation for that ad ID. The recommendation can include at least one of the following: which ad events to use or to not use to increase the likelihood of a conversion, which platform on which to serve the ad to increase the likelihood of a conversion, what season, day, and/or time to serve the ad to increase the likelihood of a conversion, what demographic to serve the ad to, whether the ad should be branded or unbranded, where to place ads on a web page, how often to serve the ad, and any other factor that can be used to improve the financial performance of that ad.

Once the advertising recommendation is calculated, at 211, it can be sent back to the publisher for implementation. For example, the recommendation can be sent to an ad publisher telling the ad publisher which advertisements to turn off, discard, or abandon, or which advertising campaign should be given prominence at a certain time.

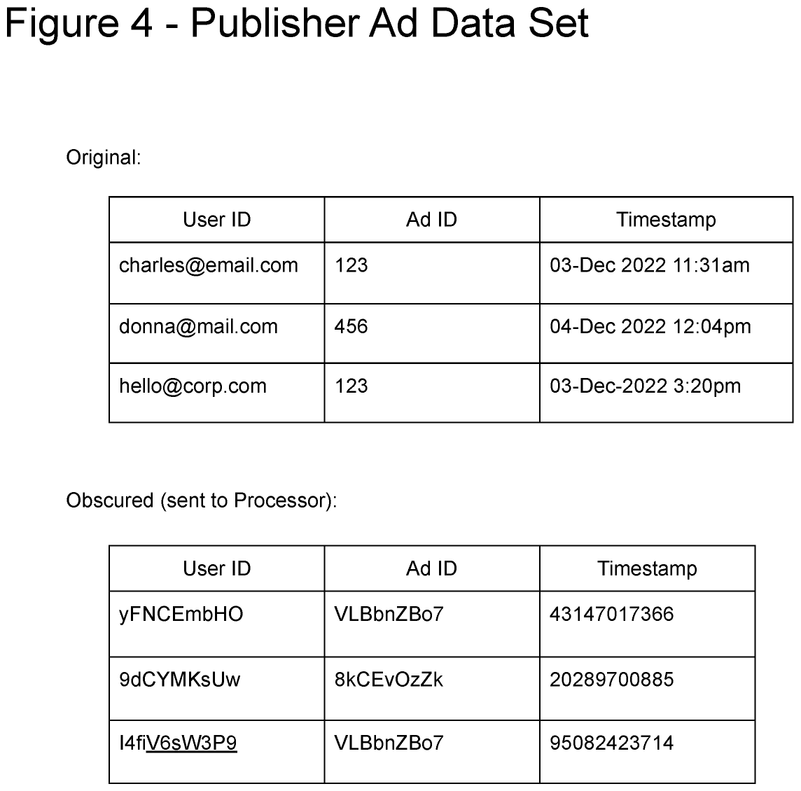

FIG. 4 is a table displaying an example of an encrypted ad data set, according to an embodiment. In an embodiment, the input file includes a plurality of rows of encrypted data, each row representing both the ad ID associated with an advertising event, along with a user ID for a user associated with that advertising event. The input file, in an embodiment, includes at least three columns, with column 1 being the encrypted keystring, column 2 representing the conversion value of that row's advertising event, and column 3 representing the revenue associated with each conversion. For the purposes of the present invention, a keystring is a collection of one or more ad IDs along with their associated values.

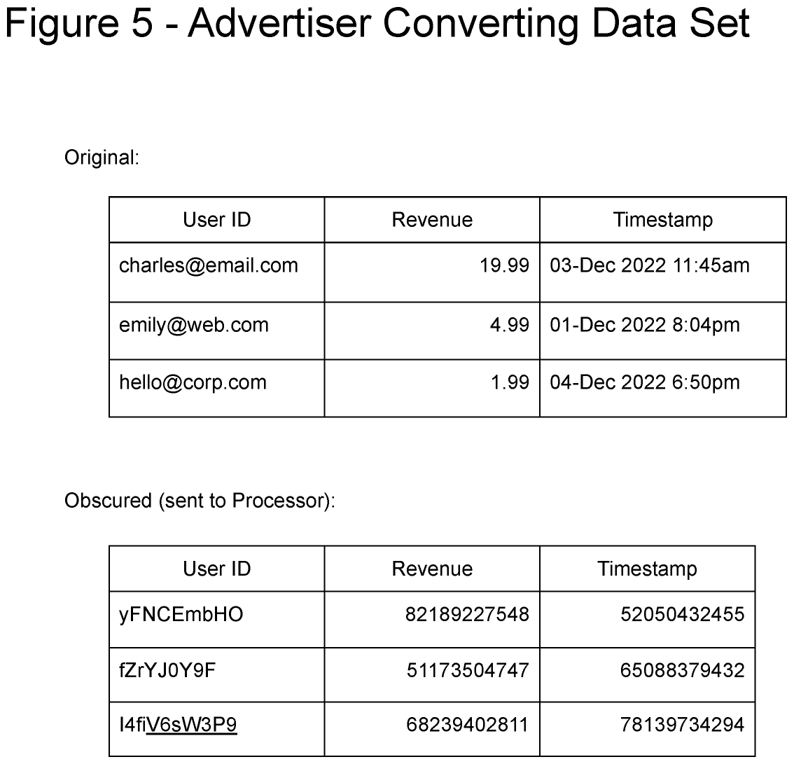

FIG. 5 is a table displaying an example of a decrypted ad data set, according to an embodiment. In an embodiment, as can be seen in the table in FIG. 5, each row includes a cleartext version of a user ID and an ad ID.

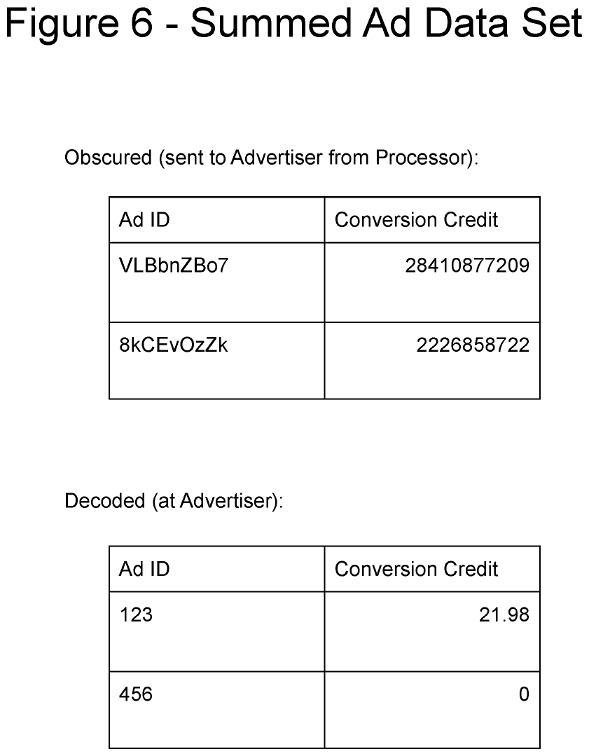

FIG. 6 is a table displaying an output file representing an aggregated data set, according to an embodiment. The aggregated data set in this embodiment comprises one row per key-value combination found in the ad data set, with the summed metric for each key value. In this embodiment, each row contains: key and value, along with metrics totals (total conversions and total revenue), with one metric displayed per field.

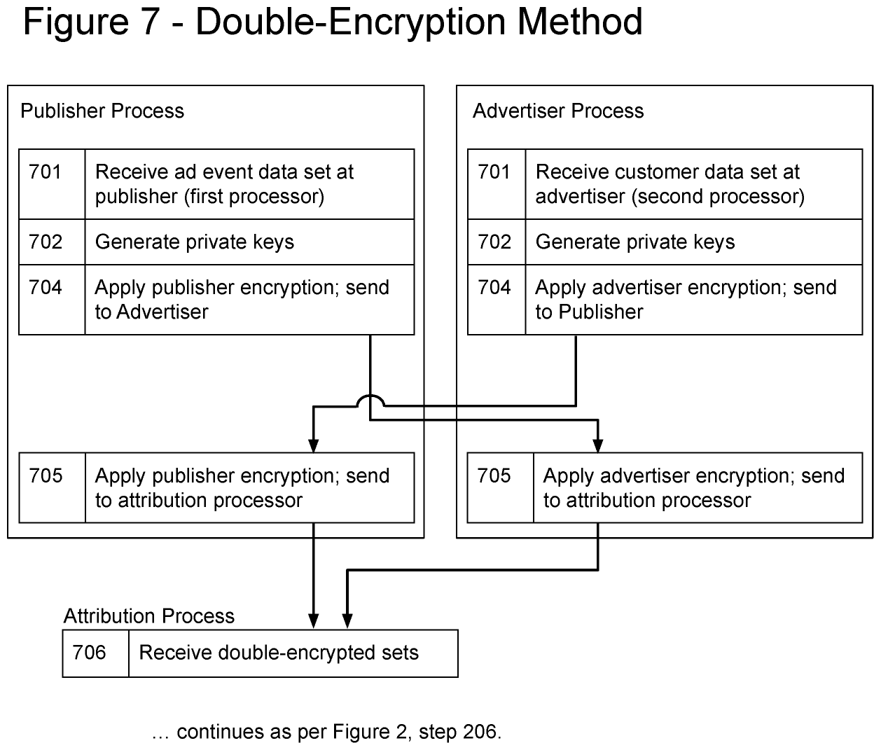

FIG. 7 is a flow chart of a method for the private and secure calculation and delivery of an advertising recommendation to a publisher, according to an embodiment of the invention. Similar to the key-coordination method, this method assumes that an advertiser has a number of users, each with a distinct user ID, and that the advertiser uses an advertising publisher, where the advertising publisher also has a number of users, each with a distinct user ID. The advertiser and publisher operate with a common universe of user IDs, for example, an email address. In contrast to the key-coordination method, this method does not require the publisher and advertiser to coordinate with each other on key selection; instead, the publisher and advertiser encrypt their own data sets with different keys, then exchange those data sets with each other to encrypt those (encrypted) data sets again. We shall refer to this method as the double-encryption method.

At 701, user IDs are received at the advertiser and at the ad publisher, where such IDs are anonymized.

At 702, each publisher and advertiser generate their own private keys and no key coordination is required. In an embodiment, these private keys are specific and relevant to an encryption scheme exhibiting associative properties; that is, Eₐ(Eₚ(x))=Eₚ(Eₐ(x)) where E(x) denotes an encryption of the original value x, and Eₐ( ) and Eₚ( ) denote the encryption function using an advertiser private key and a publisher private key, respectively. In an embodiment, elliptic curve cryptography provides the necessary associative property, that is, p·(a·X)=a·(p·X), where X is a point on the curve representing a User ID and a and p are the private keys for the advertiser and publisher respectively. The private keys are scalars generated at random and used by the advertiser and publisher respectively and not shared. The dot operation ( ) indicates an elliptic curve multiplication operation, whereby the point X is added to itself some number of times.

In another embodiment, encryption using modular exponentiation also provides the required associative property. That is, (x^{a})^{p}=(x^{p})^{a}, where x is a number representing a User ID and p and a are private exponents generated at random and used by a publisher and advertiser, respectively. It will be understood that exponentiation for encryption purposes is performed modulus a large prime number.

At 704, the advertiser and the publisher each anonymize the respective user IDs using the specified encryption approach.

In an embodiment, at 704, the Advertiser process sends its encrypted data set to the Publisher and the publisher sends its encrypted data set to the Advertiser for further encryption.

Once received, at 705, in an embodiment, the Publisher and Advertiser each again advance the encryption of the data provided by applying their own private key to the received data set. By virtue of the associative property discussed earlier, this produces a uniform-encrypted data set which can be compared across parties by the attribution processor.

At 706, the encrypted values from all contributing parties are encrypted to equivalent levels and received by the attribution processor. The attribution processor then continues as per the method of FIG. 2, step 206 to obliviously compute the intersection of the advertiser and ad publisher data. For the purposes of the present invention, an oblivious computation is a computation that has no view into the source information. Thus, the attribution processor computes the intersection without decrypting or otherwise de-anonymizing the data, and thus without seeing any user IDs and without the ability to match users to personally identifiable information. Even starting with some emails that are known to be present in the set, the data-processing party is unable to confirm if those users are present in a contributed set, as it does not know the encryption keys used to perform the encryption. Furthermore, each party uses a different encryption level for their initial encryption, preventing any one party from reverse-engineering another party's data set, even if it were to obtain access to that data set.

At 705, for each intersection found between the advertising data and the ad publisher data, a conversion credit is assigned amongst the matching ad events. In an embodiment, weightings are applied according to a series of rules set by the advertiser and communicated to the data processing party ahead of time. Rules can include how much weight to give to various events, including (but not limited to) any or all of the following: last click (publisher with the earliest time stamp); first click (publisher with earliest time stamp); even weighting (all matching publisher events get the same weighting); “U shaped” (first and last get outsized credit and ones in the middle get less); and/or recency weighted (ascending or descending weighting over time). In an embodiment, conversion events can be weighted giving greater weight to certain types of events over other types of events. One skilled in the art will understand that the aggregate sum of the credit allocated should total the conversion event value, but it may be distributed differently depending on the matching publishers.

At 706, for each contributing ad event, the values of the conversion credits are aggregated for each distinct advertising ID. Aggregated here refers to the addition of all the conversion credits, and (separately), the addition of all the credited revenue, for each ad ID. As an example, Ad ID 1 may have been seen by 100 users on a given day, of which 12 of those users purchased a product. Ad ID 1 would receive 12 conversion credits.

In an embodiment, at 706, for Ad IDs with aggregated conversion events below a certain threshold, the data processing party may further aggregate Ad IDs together to mask specific user identities. For example, if an ad received a single impression, the user who saw that ad can be identified by one party (the publisher). If that ad receives a conversion credit, and the publisher learns about that conversion credit, then the publisher can infer which user converted at the advertiser's site. Instead, the data processing party may simply say that all the ads under a certain campaign received multiple conversion credits, thus masking the identity of the users involved.

If the aggregated conversion credits decrease or increase upon a publisher removing or adding one specific user, then a malicious publisher could know that that user converted at the advertiser site. In an embodiment, at 706, the data processing party may block or approximate successive comparisons using input data that overlaps significantly with a recent comparison.

In an embodiment, at 707, the aggregated value is sent to an advertiser so that the advertiser can determine which ad events are most valuable. In an embodiment, at 707, instead of sending the aggregated value to the advertiser, the data-processing party can use the aggregated value to calculate an advertising recommendation. The calculated recommendation is sent to the publisher, who acts on the recommendation.

One skilled in the art will understand, in the context of embodiments of the invention, that the term “a combination of” includes zero, one, or more, of each item in the list of items to be combined. Additionally, one skilled in the art will understand, in the context of embodiments of the invention, that the term “advertising publisher” also includes advertising publishers' agents and others who work on behalf of publishers, such as advertising networks or advertising exchanges, and that the term “advertiser” also includes a vendor or agent operating on behalf of the advertiser.

While certain embodiments have been shown and described above, various changes in form and details may be made. For example, some features of embodiments that have been described in relation to a particular embodiment or process can be useful in other embodiments. Some embodiments that have been described in relation to a software implementation can be implemented as digital or analog hardware. Furthermore, it should be understood that the systems and methods described herein can include various combinations and/or sub-combinations of the components and/or features of the different embodiments described. For example, types of verified information described in relation to certain services can be applicable in other contexts. Thus, features described with reference to one or more embodiments can be combined with other embodiments described herein.

Although specific advantages have been enumerated above, various embodiments may include some, none, or all of the enumerated advantages. Other technical advantages may become readily apparent to one of ordinary skill in the art after review of the following figures and description.

It should be understood at the outset that, although exemplary embodiments are illustrated in the figures and described above, the present disclosure should in no way be limited to the exemplary implementations and techniques illustrated in the drawings and described herein.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

We claim:

1. A method comprising:
receiving inside a first encryption environment an advertiser customer list from an advertiser, the customer list including a plurality of advertiser user identifiers;
receiving inside a second encryption environment a publisher user lists from a publisher, the publisher user list including a plurality of publisher user identifiers;
generating an encryption key;
encrypting the advertiser user identifiers in the advertiser customer list with the encryption key to create a plurality of encrypted advertiser user identifiers;
encrypting the publisher list with the encryption key to create a plurality of encrypted publisher user identifiers;
transferring the encrypted advertiser list and the encrypted publisher list from the encryption environments to an attribution processor; and
comparing the plurality of encrypted advertiser user identifiers with the plurality of encrypted publisher user identifiers to generate a recommended advertising investment.

2. The method of claim 1, further comprising using a one-way hash function on each of the advertiser user identifiers and each of the publisher user identifiers.

3. The method of claim 2, wherein the publisher is a first publisher, the publisher user list is a first publisher user list, the plurality of publisher user identifiers is a first plurality of publisher user identifiers, the plurality of encrypted publisher user identifiers is a first plurality of encrypted publisher user identifiers and further comprising:
receiving, from a second publisher different from the first publisher, a second publisher user including a second plurality of publisher user identifiers;
using the one-way hash function on each of the second plurality of publisher user identifiers in the second publisher user list;
encrypting the second publisher user list with the encryption key to create a second plurality of encrypted publisher user identifiers;
identifying matches between the first plurality of encrypted publisher user identifiers and the second plurality of encrypted publisher user identifiers;
calculating a fractional credit amount to allocate to each intersecting publisher ad event based on a set of rules around recency and frequency, or a statistical model such as TF-IDF, whereby the sum of all the fractional credit amounts across the matching publisher event for that single conversion equals 1 conversion or (if working with revenue values), matches the total revenue for that conversion; and
summing the fractional credit amounts for each publisher ad to arrive at an advertising recommendation.

4. The method of claim 2, further comprising:
receiving an advertiser conversion value indicating a value from a conversion event;
summing the conversion values in the case of a match to create a summed conversion value for each match;
wherein the recommended advertising investment is based on the summed conversion value.

5. The method of claim 3, further comprising:
multiplying each of the fractional credit amounts by a conversion value to arrive at a weighted fractional credit amount for each fractional credit amount; and
summing the weighted fractional credit amounts to create a set of summed fractional credit amounts;
wherein the recommended advertising investment is based on the summed conversion value.

6. The method of claim 1, and further comprising:
receiving, for each advertiser user identifier in the advertiser customer list, an advertiser timestamp of a conversion; and
receiving, for each publisher user identifier in the publisher customer list, a publisher timestamp of a visit;
wherein the recommended advertising investment is a function of an intersection between the advertiser timestamps and the publisher timestamps.

7. The method of claim 1, and further comprising:
receiving in the publisher user lists a set of attributes about each visit;
including the set of attributes in the encrypted publisher user list;
matching encrypted publisher user identifiers with encrypted advertiser user identifiers by at least one attribute to create a set of matched identifiers; and
aggregating a conversion value of the each matched identifier in the set of matched identifier.

8. The method of claim 1, wherein each advertiser user identifier and each publisher user identifier corresponds to a conversion event, further comprising:
receiving, for each advertiser user identifier in the advertiser customer list, a set of attributes about that conversion event;
receiving, for each publisher user identifier in the publisher user list, a set of attributes about that conversion event;
aggregating a conversion value separately for each event type to create an aggregated conversion value;
and wherein the recommended advertising investment is a function of the aggregated conversion value.

9. The method of claim 4, and further comprising:
encrypting the conversion value within the advertiser encryption environment using an additively homomorphic encryption scheme to create a set of encrypted values;
adding together each value in the set of encrypted values to create an aggregation;
transferring the encrypted and aggregated values to the encryption environments; and
decrypting the encrypted aggregated values to arrive at an advertising recommendation that masks the conversion values from the comparison environment.

10. The method of claim 6, further comprising:
masking the timestamps within the encryption environments in such a way that they can be compared to determine at least one of the relative sequence of the timestamps or the difference between the timestamps, but without revealing the timestamps themselves; and
comparing the masked timestamps within the comparison environment to determine at least one of the relative sequence of the timestamps or the difference between the timestamps, without using unmasked timestamps for the comparison.

11. The method of claim 7, further comprising:
encrypting the each attribute inside the encryption environment(s) in a way that masks a value attributed to each attribute from the comparison environment;
aggregating a conversion count for each distinct encrypted attribute, and aggregating a conversion value for each distinct encrypted attribute to create a conversion data set that includes the aggregated conversion count and the aggregated conversion value;
transferring the conversion data set from the comparison environment back to at least one encryption environment;
decrypting the conversion data set inside the encryption environment; wherein the recommended advertising investment is related to the decrypted conversion data set.

12. The method of claim 4, further comprising:
applying an upper limit to the summed conversion value to the encrypted advertiser customer list, the upper limit chosen to prevent identification of a specific user's inclusion in the publisher user list.

13. The method of claim 3, and further comprising:
calculating a non-converting visit list by
identifying which user identifiers are present in the encrypted publisher user list and that are not present in the encrypted advertiser list; and
comparing a relative volume of converting and non-converting lists to create a model to allocate credit to publishers for converting users.

14. The method of claim 1, further comprising:
receiving one or more user identifiers for each distinct user from both advertisers and publisher(s);
inside the encrypted environment(s), encrypting all the received user identifiers and storing each in the encrypted publisher or advertiser list; and
identifying either the encrypted advertiser customer list or the encrypted publisher user list(s) as the comparison subject(s), and the other list type as the comparison object(s).
comparing for each potential user each of the user identifiers from the subject list(s) with the all of the publisher user identifiers from the object list(s) until the first of (i) a match is found and (ii) there are no further user identifiers from the subject list(s).

15. The method of claim 14, further comprising:
including, in at least one of the advertiser customer list or the publisher user list, randomly generated fictional identifiers such that the including of such identifiers reduces the probability that a specific user can be identified.

16. A method comprising:
receiving, at an attribution processor, an ad event data set that includes data about a plurality of ad events, and further includes a user ID and an ad ID for each ad event in the ad event data set, and where the ad event data set has been anonymized applying a one-way encryption key for each user ID in the ad event data set, and a two-way encryption key for the ad ID in the ad event data set;
receiving, at the attribution processor, a customer data set that includes data about a plurality of customers, including a user ID and a customer value for each customer in the plurality of customers, and where the customer data set has been anonymized using the one-way encryption key for each user ID in the data, and the two-way encryption key for each ad ID in the data;
without decrypting the received ad event data set and the received customer data set,
identifying matching ad events for each conversion by comparing the user IDs in the encrypted ad event data set to the user IDs in the encrypted customer data set to create a set of contributing ad events;
assigning a share of the customer value to each ad event in the set of contributing ad events;
summing the customer values for each ad ID across contributing events to create a converting ads data set;
determining, based on the converting ads data set, a recommendation as to the relative value of at least one ad in the ad event data set.

17. The method of claim 16, where the attribution data set is received from a publisher, and where the customer data set is received from an advertiser, and further comprising:
sending the summed ad conversion values to the advertiser in a format that allows for the decryption by the advertiser.

18. The method of claim 17, further comprising:
decrypting, at the advertiser, ad IDs and summed conversion values;
dividing the summed ad conversion values by at least one of ad volume or spending, and wherein the recommendation is based on said dividing.

19. The method of claim 18, further comprising:
sending the advertising recommendation to the publisher.

20. The method of claim 16, further comprising
generating the encryption key;
encrypting the ad event data set using the encryption key;
encrypting the customer data set using the encryption key.

21. A method comprising:
receiving, at an attribution processor, an ad event data set that includes data about a plurality of ad events, and further includes a user ID and an ad ID for each ad event in the ad event data set, and where the ad event data set has been anonymized applying a first one-way encryption key for each user ID in the ad event data set, and a first two-way encryption key for each ad ID in the ad event data set, and a second one-way encryption key for each user ID in the ad event data set, and a second two-way encryption key for each ad ID in the ad event data set;
receiving, at the attribution processor, a customer data set that includes data about a plurality of customers, including a user ID and a customer value for each customer in the plurality of customers, and where the customer data set has been anonymized using the first one-way encryption key for each user ID in the data, and the first two-way encryption key for each ad ID in the data, and a second one-way encryption key for each user ID in the data, and a second two-way encryption key for each ad ID in the data;
without decrypting the received ad event data set and the received customer data set,
identifying matching ad events for each conversion by comparing the user IDs in the encrypted ad event data set to the user IDs in the encrypted customer data set to create a set of contributing ad events;
assigning a share of the customer value to each ad event in the set of contributing ad events;
summing the customer values for each ad ID across contributing events to create a converting ads data set;
determining, based on the converting ads data set, a recommendation as to the relative value of at least one ad in the ad event data set.
